(19) United States
(12) Patent Application Publication
(10) Pub. No.: US 2010/0017714 A1
(43) Pub. Date: Jan. 21, 2010

(54) WEB BASED COLLABORATIVE MULTIMEDIA EVENT PLANNING, HOSTING AND DEPLOYMENT SYSTEM AND WEB BASED PERSONAL MULTIMEDIA PORTABLE SYSTEM

(76) Inventors: ANJILI AGARWAL, Ladera Ranch, CA (US); ANIL AGARWAL, Ladera Ranch, CA (US)

Correspondence Address: MICHAEL RIES, 318 PARKER PLACE, OSWEGO, IL, 60543, US

(21) Appl. No.: 12/503,842

(22) Filed: Jul. 16, 2009

Related U.S. Application Data
(60) Provisional application No. 61/081,285, filed on Jul. 16, 2008.

(51) Int. Cl. G06F 3/01

(52) U.S. Cl. 715/716; 715/753; 715/810; 707/104.1

(57) ABSTRACT

A web based secure interactive system that hosts one or more events that can be accessed over the internet. An organizer or host organizes an event, creates an invitee list of individuals, and composes an invitation message, the organizer or host shares, communicates and tracks the current status of each individual on the list and allows the same visibility to each invitee. The organizer or host also interacts with the invitees to create a collaborative multimedia playlist and posts multimedia clips of shared moments at or during an event. The host creates a secure intra-group instant chatting regarding the current event or events for instant activity updates and intra group communication.

A web based secure interactive system for small to large establishments that allows owners of these establishments to collaborate with their patrons to create engaging multimedia entertainment.

### REFERENCE TO RELATED APPLICATION

This patent application claims the benefit of U.S. Provisional Application No. 61/081,285 filed on Jul. 16, 2008, the disclosure of which is incorporated herein by reference in its entirety.

### BACKGROUND OF THE INVENTION

1. Field of the Invention

The present invention relates generally to web based multimedia systems and more particularly to web based collaborative event planning and hosting an event that includes multimedia playlists, food and other items. Additionally, the system is applicable to web based collaborative multimedia playlist creation and play management for small, medium and large establishments that interacts with their patrons on an ongoing basis. Additionally, the system is applicable to personal web based multi media systems that can be accessed anytime anywhere.

2. Background of the Invention

The World Wide Web has changed the way that people interact with each other and organize their personal information. Wireless devices with their infrastructure and connectivity to the World Wide Web have allowed people to manage information and communicate anytime from anywhere with the rest of the members of society. People use web enabled devices to search for information and use the connectivity tools and applications to improve their quality of life and their day to day productivity. Some of the more prominent companies like Google, Yahoo, Facebook, Myspace, Youtube, Twitter and others have created new ways to search for information, communicate with peer groups and publish personal information to be shared with their friends and family members. Wireless devices make extensive use of SMS (short messaging system) as well as MMS (multimedia messaging system) and World Wide Web based tools to communicate with their friends and family members. Great advances will be made in the coming years to make these devices user friendly and more interactive.

Human society uses a considerable amount of their time to have regular get together(s) and social interactions for various occasions. These occasions are varied from celebrating special events in someone's life, achievements of certain individuals or groups and they require extensive planning, coordinating, and finally arranging for all the various items to be delivered for the guests to enjoy the event. Most of this event planning is done by the host or hired professionals who use various methods from paper or computer excel spreadsheets to arrange details of the event. They use telephone, email, SMS messaging system to inform their guests of the event e.g. location, occasion, theme, place, and time of the event etc. Much of this work is very time consuming for the host or organizer and mistakes and anxiety are prone to occur.

In recent years web based invitation systems have been offered by various companies. One such company is “Evite” and they offer a friendly web based system that allows the host to send an electronic invitation for a party to the guests and receive the guest response if they plan to attend the event. However, most of the events revolve around music, video (multimedia) and food. The host would love to create an exciting event which would allow the guests to experience a sense of belonging and involvement, by sharing their choices regarding music, videos, food so they can be attached to the event emotionally. Prior electronic invitation systems do not allow an interactive collaboration between host and guests. In particular, the host and guests are not able to search, interact and collaborate to construct a master multi media play list that can then be used to create a multimedia jukebox which can be played by the host or organizer at the event. Similarly, current systems do not allow collaboration with the guests to finalize food menu and assignments to various members invited to the event.

The last few years have seen a proliferation of personal multimedia devices with self contained memory for multimedia content to be played by the user anytime anywhere. Some of the products are offered by companies like Apple, Samsung, Sandisk and others. Additionally, the internet availability allows these web enabled devices to play multitude of multimedia content from companies like Youtube, MTV and other entertainment and news broadcasting companies. However, a web based personalized mobile system to organize the multimedia content in distinct categories to avoid carrying of multiple devices has not been described and offered up to now.

What is needed is an easy to use web central server based personal web based secure server based system that allows a user to search, select, organize, and update multimedia content that can be later accessed to be played from anytime anywhere on any multimedia enabled devices, without the need of dedicated expensive storage for this multimedia content.

Another area of social interaction in our society happens at small to large establishments that provide multimedia entertainment at their locations. Visitors are offered predetermined multimedia entertainment. What are needed are a more interactive and collaborative multimedia entertainment systems to deeply engage the visitors.

### SUMMARY OF THE INVENTION

The current invention describes an easy to use web enabled interactive response system where the host can collaborate to search, preview, create a multimedia playlist for the event, and finally create a rank ordered multimedia juke box to play this multi media playlist for everyone's entertainment.

Another unique description of the collaborative system is to be able to create a secure intra group instant communication platform, for one or more unique events. Similarly, the current invention describes an interactive web based response system that allows the host and invitees to interact, collaborate and finalize the food menu to be served and assign the invitees of their portions of the food menu. The system makes it very simple for the host and invitees to see the final list and who is bringing what to avoid last minute confusion. These and other features for the current invention of web based collaborative creation/response system for event planning will be described in more detail in later sections.

Another unique description of the collaborative system is to be able for the small, medium and large institutions to collaborate with their patrons to offer a much more engaging multimedia entertainment of their choice. The patrons interact with the web based system to enter their multimedia choices for certain dates and time. The owner of these establishments use these requests to create rank ordered multimedia playlists with requesters names, that is then played using web enabled multimedia playback devices. This allows a new level of engaging entertainment and patron loyalty.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings.

FIG. 1 is an illustration of Web Based Collaborative Multimedia Content Deployment System;

FIG. 2 is an illustration of design flow for the web based collaborative multimedia host module;

FIG. 3 is an illustration of Host user interface for Creating Event Information;

FIG. 4 is an illustration of Host user interface for Creating Guest List;

FIG. 5 is an illustration of Host user interface for collaborative multimedia playlist module;

FIG. 6 is an illustration of Host user interface for collaborative multimedia Search Module;

FIG. 7 is an illustration of collaborative multimedia content jukebox;

FIG. 8 is an illustration of Host use interface for Web based Invitation and tracking Guests;

FIG. 9 is an illustration of Web based interactive Intra-group communication module;

FIG. 10 is an illustration of Web based collaborative multi-media Guest/Invitee module;

FIG. 11 is an illustration of Web based Featured Events Module;

FIG. 12 is an illustration of Web based Central Personal Information Module;

FIG. 13 is an illustration of Design Flow for Web based Collaborative Multimedia Mobility Module;

FIG. 14 is an illustration of Guest user interface for Interactive Viewing Event Module;

FIG. 15 is an illustration of Guest user interface for Interactive Viewing Event Module;

FIG. 16 is an illustration of Guest user interface for Viewing Shared Moments;

FIG. 17 is an illustration of Web based Personal Multimedia Module;

FIG. 18 is an illustration of Web based Personal Multimedia Module;

FIG. 19 is an illustration of Web based Personal Multimedia Jukebox;

FIG. 20 is an illustration of Venue Host user Interface for collaborative multimedia playlist module;

FIG. 21 is an illustration of Venue Host user interface for collaborative multimedia Search Module;

FIG. 22 is an illustration of Venue Host collaborative multimedia jukebox;

FIG. 23 is an illustration of Venue Patron Interactive multimedia Playlist;

FIG. 24 is an illustration of Venue Patron collaborative multimedia Content Search Results;

FIG. 25 is an illustration of Collaborative Food Menu User Interface; and

FIG. 26 is a diagram of a computer system for use with the present invention.

### DETAILED DESCRIPTION OF THE INVENTION

Using the World Wide Web communication between personal computers, home entertainment devices, and hand held devices such as phones; a new interactive and collaborative system to securely organize and host fun and exciting events is described. The host/organizer and the guests/invitees interactively collaborate instantly anytime from anywhere using internet access, to plan a party or an event with instant feedback from invitees. The system allows the guests to solicit instant feedback from the invitees for entertainment activities such as music, videos, food and others. The host is able to create/play multimedia clips (audio & video), serve food and other entertainment to the groups liking at the event thereby creating a sense of greater involvement from the invitees to make the event more fun and exciting.

The system allows a host to create an event with relevant information regarding the event, create an invitee list, create their own personal rolodex for future usage, and send an electronic invite to all the guests informing them of the event and requesting them to add their requests of multimedia playlists, food choices, to be included/served at the event. The system is flexible that allows a creation of a dedicated communication module within the members of the newly created group to instantly chat and share information pertaining to the event, and be able to create excitement and fun for a true social interaction.

The host and guests use an easy to use multimedia search capability. The users preview and then select one or multiple multimedia songs and clips, add messages/dedication to be shared with the group. The host is able to author/create a multimedia jukebox. The system enables the host to finalize the multimedia list, rank order and preview/create a jukebox. The host then invokes the web enabled jukebox to stream/play the multimedia clips using any audio/video equipment to be enjoyed by the group. The host can also send the finalized multimedia list to a professional DJ to play the multi media clips selected by guests prior to the event.

This collaborative system allows the host to coordinate food dishes to be served at the event and solicit feedback from guests. The system is also able to create a food menu, and coordinate a potluck or shared food event for the guests to pick their own dishes/drinks with quantities to avoid confusion and reduce time to coordinate an event.

The system allows an easy way for host and invitees to upload multimedia clips shot at the event to be shared by all the members after the event is concluded.

Another method for the collaborative system that is described is to be used by small, medium and big establishments, who can now interact with their patrons for creating a collaborative multimedia playlist for certain days and time, author/create a collaborative multimedia jukebox. The system allows for creating special multimedia events and links to individual websites for creation of collaborative multimedia events.

The system allows users to create their own personal directory of multimedia clips (audio and video) that can be accessed and played anytime anywhere on any device that has web access and capable to play multimedia clips, thus avoiding any need for dedicated multimedia devices.

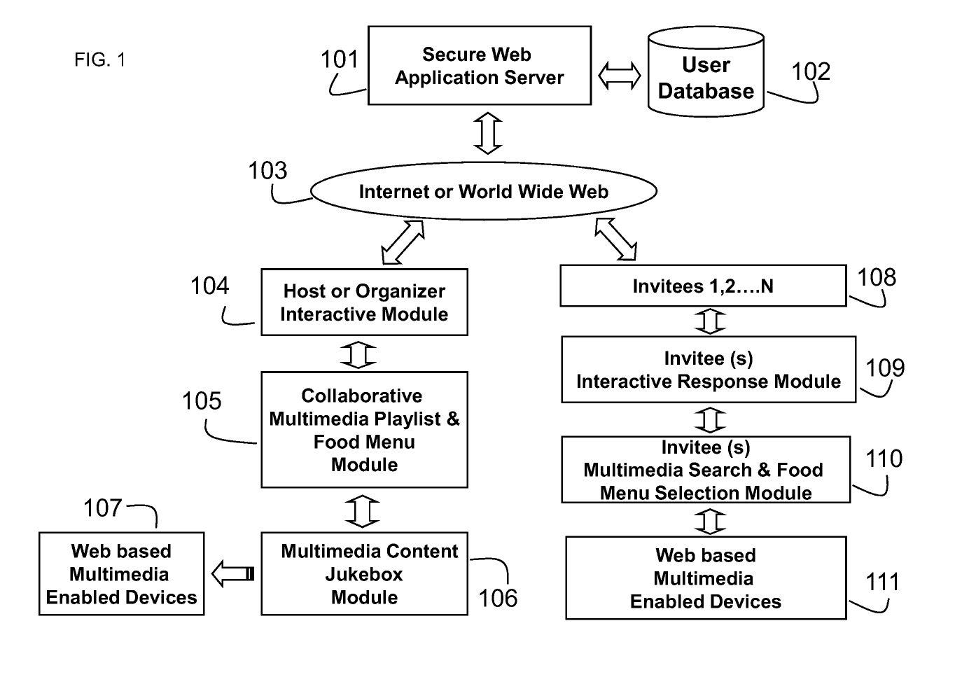

Referring now to FIG. 1, there is shown a flow chart of a novel web based collaborative multimedia content deployment system. FIG. 1 shows the schematic for the various functional modules that are connected via the internet backbone (103) and clearly shows the preferred embodiment of the current invention, where the host (104) and guests (108) are capable to interact and collaborate to create a multimedia list (105), that is converted to a multimedia jukebox (106), and then shared using multimedia enabled devices during the event (107).

The application server hosts the main application (101) that is secure and is available to be accessed by users, using web connected devices such as personal computers, hand held computers, multimedia entertainment consoles, and mobile phones etc. User database (102) is used to store user names and passwords for various users, and is secured using the state of art encryption technology to avoid inadvertent access to private data. The guests interact and collaborate via the web based interactive module (109, 110) to help the host create a collaborative multimedia playlist or a food menu. The guests can also preview the multimedia playlist through a web enabled multimedia devices (111).

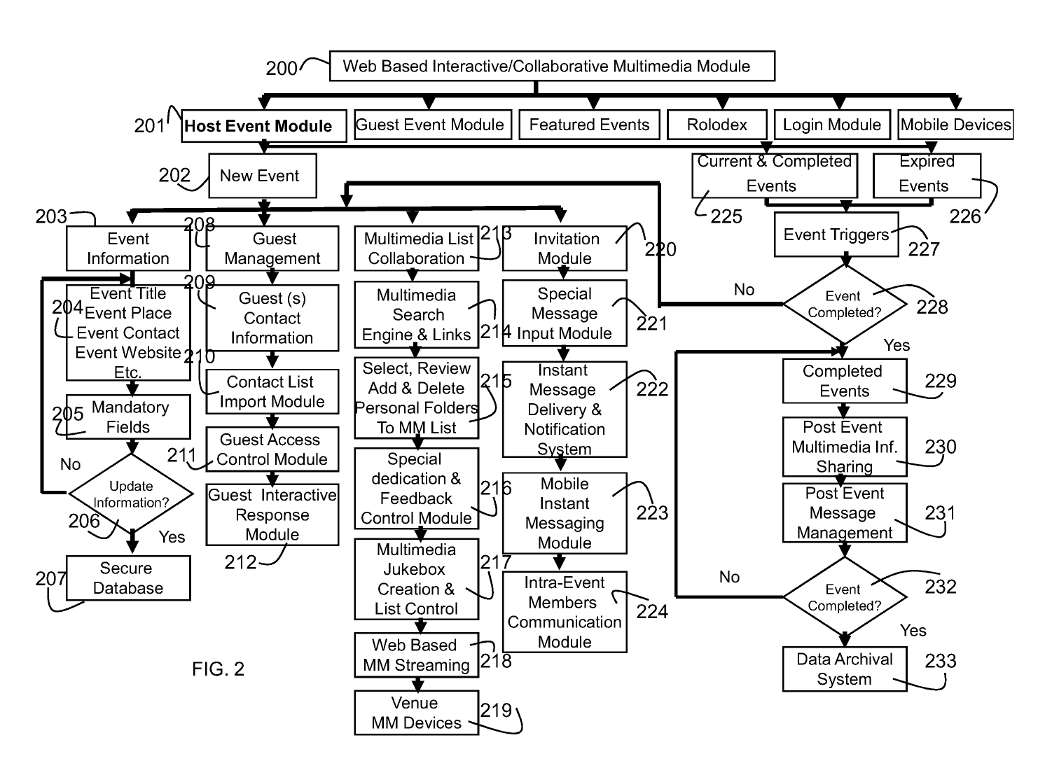

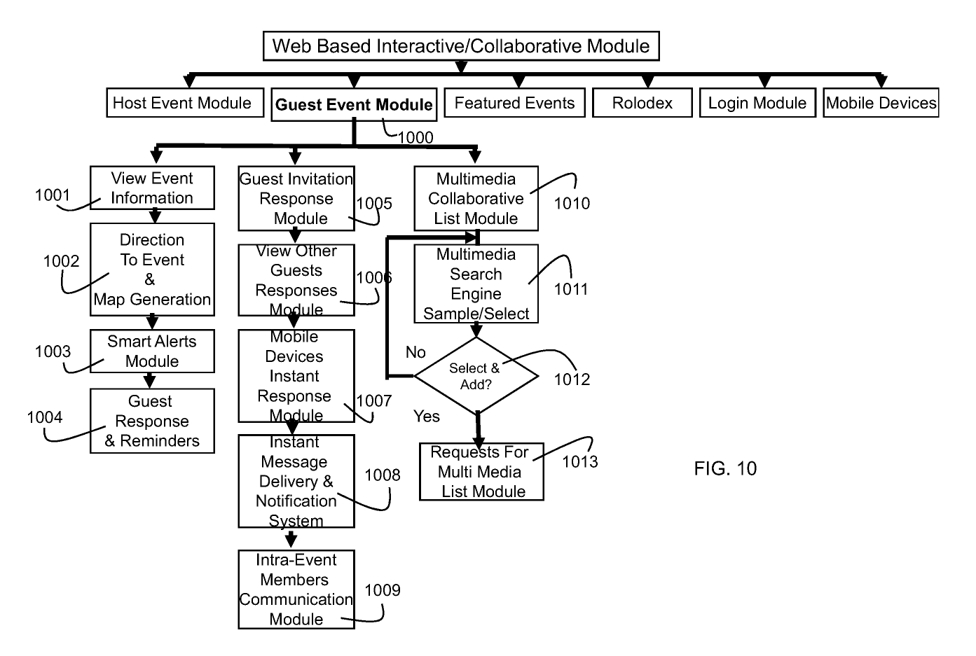

FIGS. 2-16 show a preferred embodiment of the current web based collaborative multimedia invention for the host to plan an event using an interactive module. This interactive module contains preferred ways tor the guest and host to communicate their choices, chat instantly over the internet that is shared by the entire subgroup anytime, anywhere. FIGS. 2-9 show a novel collaboration module for the host to interact over the internet with the guests, to create multimedia playlist or food menu that becomes an essential part of entertaining for the planned event. Another unique module of this invention is for the host to author (create, add, delete, rank order, dedication) a multimedia jukebox based on the feedback from the guests when creating the multimedia list. The multimedia content of the customized jukebox is then streamed live using the web based application server and subsequently shared with the guests at the event using a web enabled multimedia devices. FIG. 10-16 also shows the Invitee(s) interactive response module that contains ways for the invitees to view the invitation to the event and its details. The invitees are allowed to communicate with the host instantly over the internet. The guests can chat and also post messages to be shared with the rest of the members of the group. FIGS. 10-16 also shows a unique multimedia search/selection module that consists of allowing the guests to search multimedia content and them select one or multiple requests along with a dedication for the event for the host's consideration. Once the guests add the request for one of multiple clips, these are made visible for the entire group for easy collaboration. Similarly, the guests are allowed to collaborate to finalize the food menu for the event through this module.

FIG. 2 illustrates the design flow for the host module for the web based collaborative multimedia system (200). The host (201) will start by creating a new event (202). The host can then enter the details of the event (203) such as event title, place, time, contact etc. (204). Some of these fields are clearly denoted as mandatory fields (205) for the database to uniquely identify the event.

The system allows the host to update the information if there are any changes to the event details (206). The host can keep and then send the information to the internet based central secure database (207). The host invokes the guest management module (208). The host can enter the guest contact information (209) directly into the easy to use table or import the contact information from a variety of other web based address books such as Google, Hotmail, MSN, Yahoo and others (210).

The host can also specify if one or more guests are allowed access to interact with the rest of the group members (211). The host and guests interact via the interactive response module (212) to accept, decline, or undecided the invitation. The guest can post messages that are shared with other members of the group. The next utility called as multimedia list collaboration (213) describes another embodiment of this invention.

The host starts with searching multimedia content using a multimedia search engine (214). The host can choose to preview one or more items in the search list, add one or more items to the starter multimedia list (215). The host adds his/her own comments to one or more items and this starter multimedia list is instantly made visible to the guests (216). The guests also add their requests along with their dedication via the guest module described later. As the event date comes closer, the host uses yet another novel embodiment of this invention to be able to create a multimedia jukebox (217) that uses all the feedback and requests from the guests.

The host can preview the requested songs, delete, rank order the items on the finalized list for the final multimedia jukebox stored on the web based server to be shared with the guests at the event. At the event the web enabled multimedia devices are used to stream the multimedia content of the jukebox over the internet (218) and played via multimedia enabled devices (219). After the host has set up the event, created a starter multimedia list, the next step is to send the invitation (220) over the internet to all the guests (221) letting them know of the event as well as the new unique capability for them to collaborate to create a multimedia list for the upcoming event (222). The invitation messages and the response are instantly shared with all the guests for them to start interacting immediately from anywhere, anytime using mobile instant messaging module (223).

Another novel embodiment of the current invention is for the host and guest to invoke a novel instant chat utility to follow the discussion regarding that particular event with other members of the group event (224). Blocks (225-233) are ways to manage current and expired events to create event triggers for upcoming event and to share memories of an expired event.

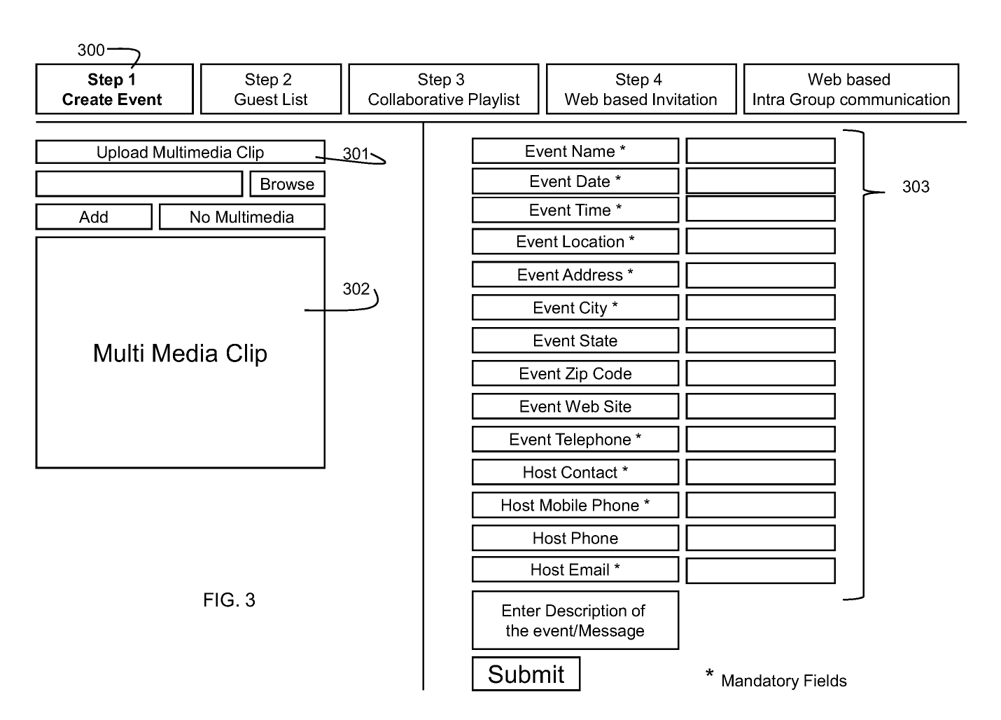

FIG. 3 shows Host use interface for Creating Even Information. In FIG. 3, block (300), the host creates an event and all the related information regarding the event including mandatory fields (303). The host is able to upload a custom multimedia clip (301) to personalize the event. The multimedia clip that is uploaded is displayed for preview (302) and shared with the guests.

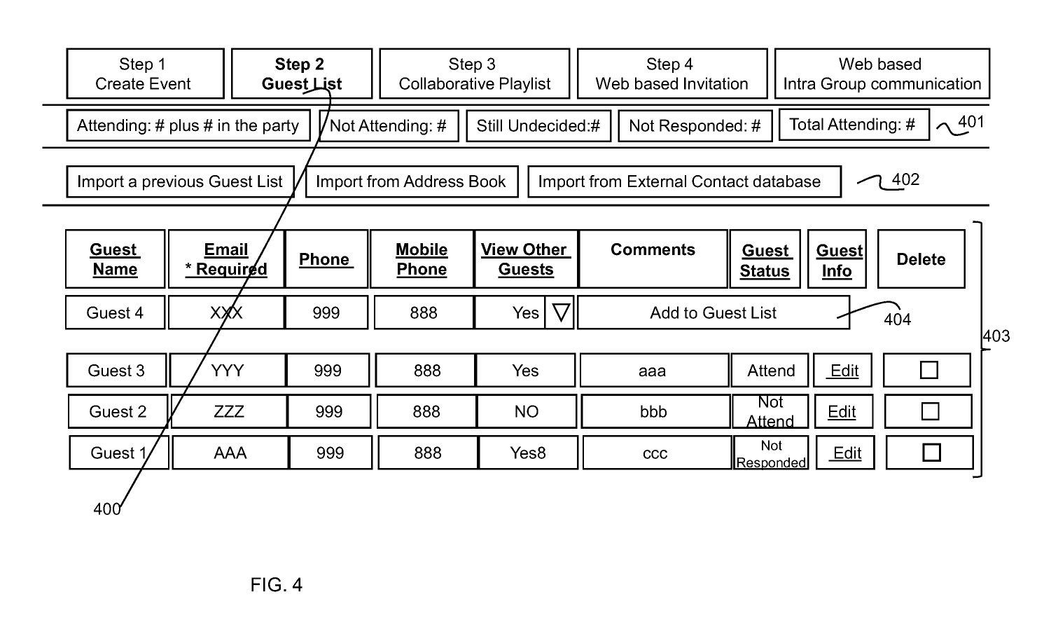

FIG. 4 shows block 400 for the host to create the guest list. The system keeps an automatic track of the number of guests attending and their status (401) and is instantly updated with most current data via the internet. The host can import the contacts of the guests through various means that includes contact data bases such as GMAIL, MSN, etc., previously organized events (402). The host is allowed to add one or more guests via a simple to use interactive dialog box (404). Once entered the complete table is displayed (403) for host to view guest list, status of the guests, and instant messages from the guests.

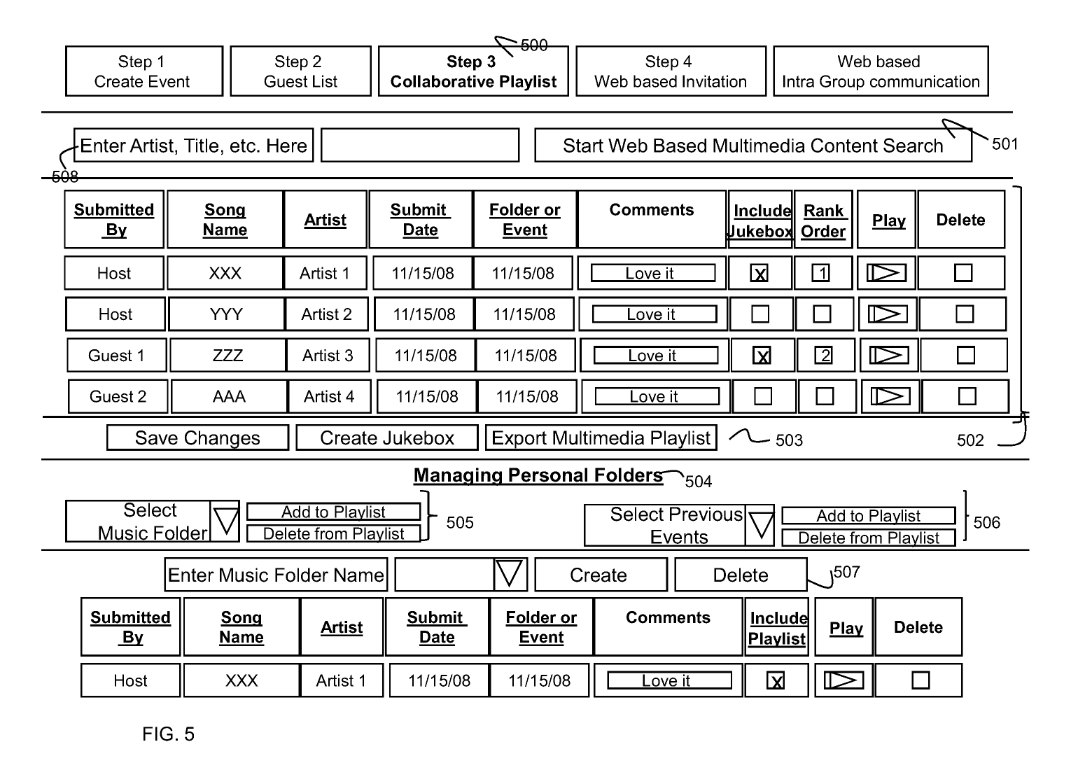

FIG. 5 shows one of the preferred embodiments for the host user interface for the interactive web based collaborative multimedia playlist creation (500). The host is presented with a multimedia search engine dialog box. The host can invoke the web based search for a variety of multimedia content (501). The host can then preview, add one or more items to the started multimedia playlist (502). The host can also add comments to be shared with other guests (502). The host can then save the changes and also export the multimedia playlist (503). After the host receives all the requests from the guests the host can rank order the playlist. A novel way is described to use automatic dynamic rank ordering system for the host to quickly assemble the final multimedia playlist. The hosts can simply check mark the multimedia content that is included in the final multimedia jukebox. The host can also rank order one or more items on the selected multi media list to clearly indicate the play sequence of the multimedia content at the event by the host or other organizers of an event on their behalf. Once satisfied, the host can now create a multimedia jukebox (503). Another novel embodiment of this invention is to allow the host to create personal folders on the web based secure folders (504-507) in which the users can create their own multimedia content library for future reference and usage. If the user chooses multimedia content from a previous folder it is indicated clearly the location of the multimedia content library folder (507). As mentioned before in the design flow and now shown here clearly the novel embodiment of this invention is a very easy way for the host to view all the multimedia play requests as well as their personal dedication or messages from the invited guests, and then to start finalizing the multimedia playlist for the event.

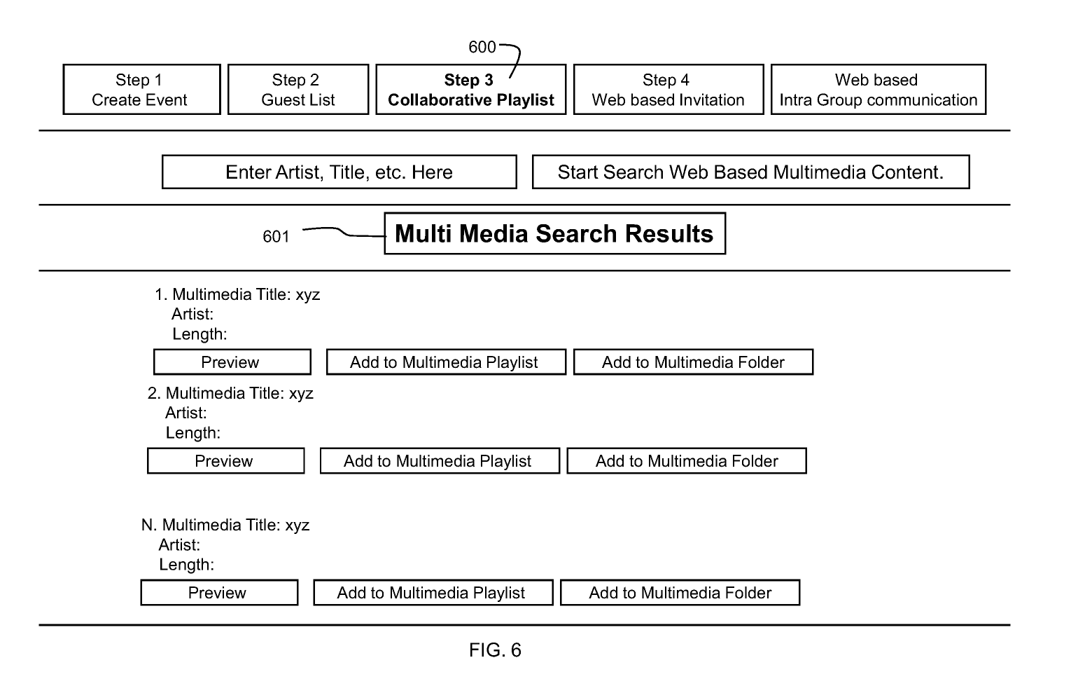

FIG. 6 shows the multimedia search results (601) during the creation of collaborative playlists (600). The host can then select from the various choices as shown in FIG. 6 returned from the search. The hosts can simply check mark the multimedia content that is included in the final multimedia jukebox.

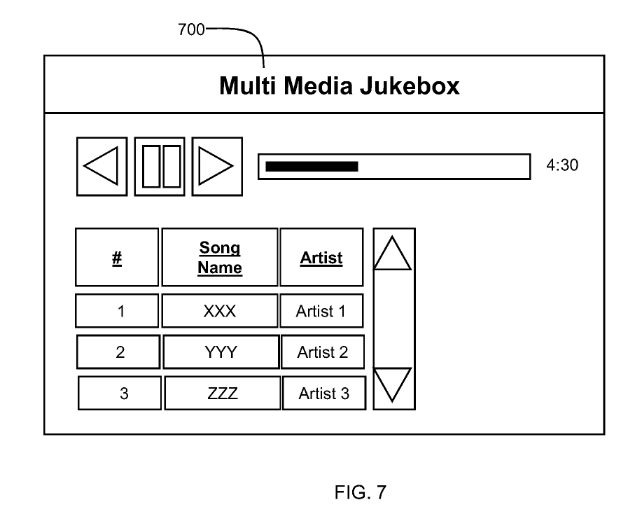

FIG. 7 shows the multimedia jukebox 700 that contains the rank ordered multimedia content previously described. The multimedia content is streamed live over the internet from the web based secure server and can be played on one or more multimedia enabled device platforms for either small groups or larger groups. Another novel embodiment of this invention is the flexibility of the web based collaborative system to update the multimedia playlist for instant requests that can be included instantly in the multimedia jukebox.

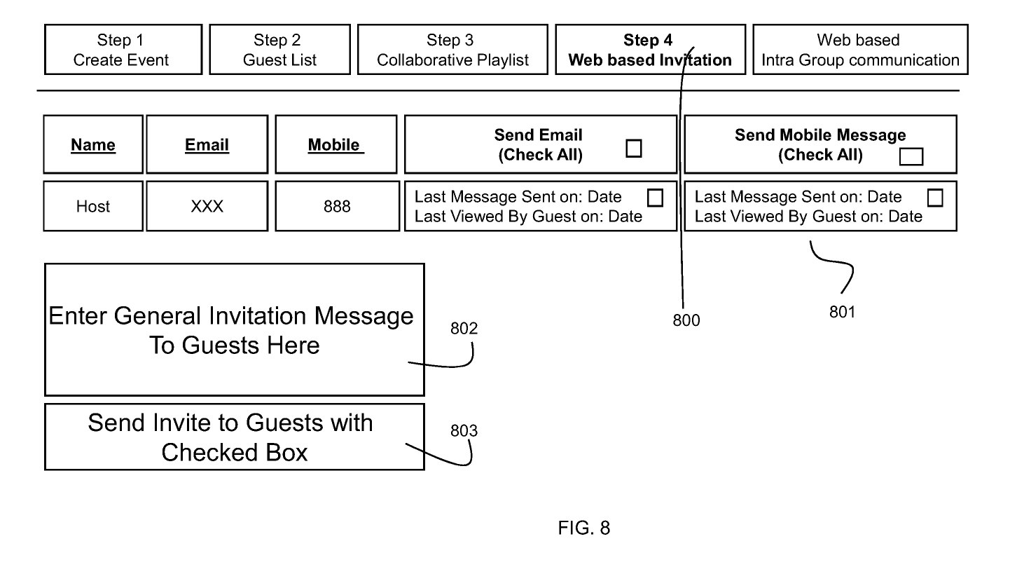

FIG. 8 shows one of the preferred embodiments of the web based invitation module (800). The host is able to track the invitation history. A unique method shows a way for the host to see if the guests have viewed their invitation (801). The host can send updated messages to selected guests (802-803).

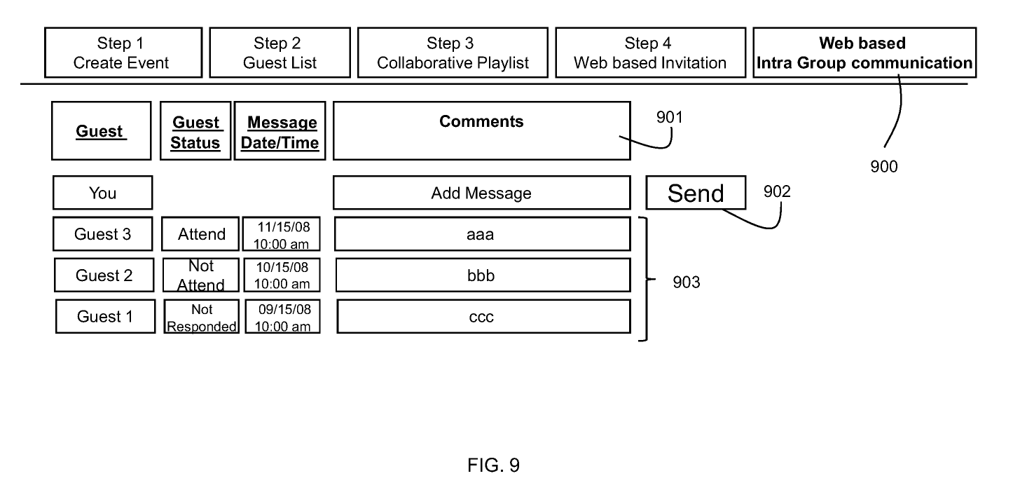

FIG. 9 shows a unique way for the members of the event to communicate within the group instantly (900). The host and guests can compose short messages and send them instantly over the internet (902). The messages from all the members are displayed (903) instantly for creating a fun and excitement regarding the event for enhanced experience in social networking. The gust status is also constantly updated and displayed (901) for most current information regarding the guests.

FIG. 10 shows the design flow for the guest module (1000) for the web based collaborative multimedia module described in FIG. 1 above. The main embodiment of this invention is to allow the guests to collaborate (1010) with the host to provide individual requests (1011-1013) that can be part of the multimedia jukebox to be shared at the event. The guest is able to view the multimedia master list started by the host and requests from other guests with their dedication. This is continuously updated as changes are made to the list. One or more guests invoke the search engine for multimedia content search (1011), previews and select one or multiple items from the list, and submit the requests to be added to the master list. The guest also adds personal messages for individual items that have been selected. Another embodiment of the guest module is to be able to instantly communicate/respond via the guest response module (1005). The guest can accept, decline or not decide to attend the event. The novel embodiment of this invention is for the guest to instantly view responses from other guests (1006) as well as communicate with members of the new sub group (1009). The guest receives instant reminders (1008) about the event on their web enabled devices, mobile or stationary (1007). The guests are able to view event information details (1001), and links to maps to the event location from internet based map services such as Google maps (1002). Guests are sent alerts and reminders (1003) via the smart alerts module to which the guests can respond through the web based interactive module and update the rest of the group instantly (1004).

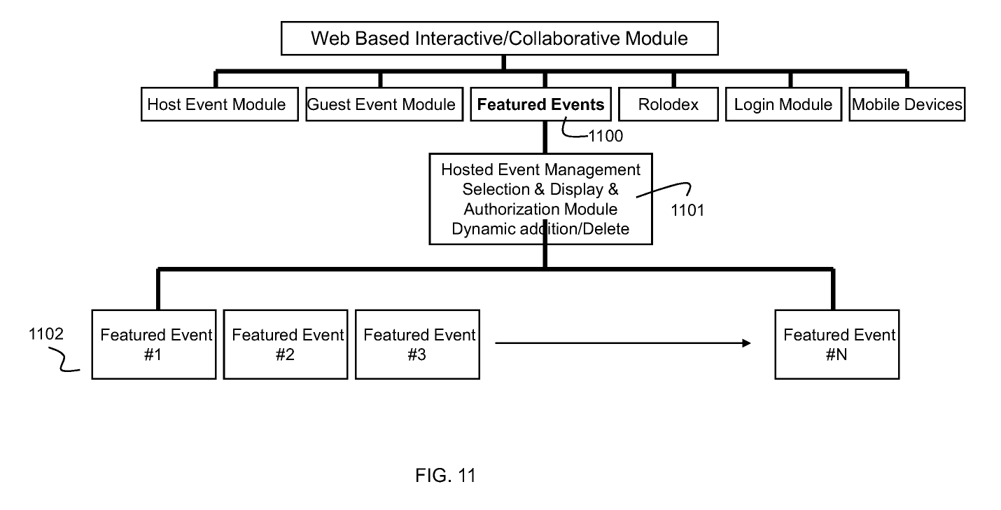

FIG. 11 shows a unique way to showcase selected multimedia playlist (1100) that have been hosted by various users. The featured events are managed dynamically to be added to the display box for viewing by users outside the immediate members of the event. Security is maintained to not reveal personal information. This is managed by host management module (1101). The featured events that are selected are displayed in the block (1102) and able to be rotated for viewing.

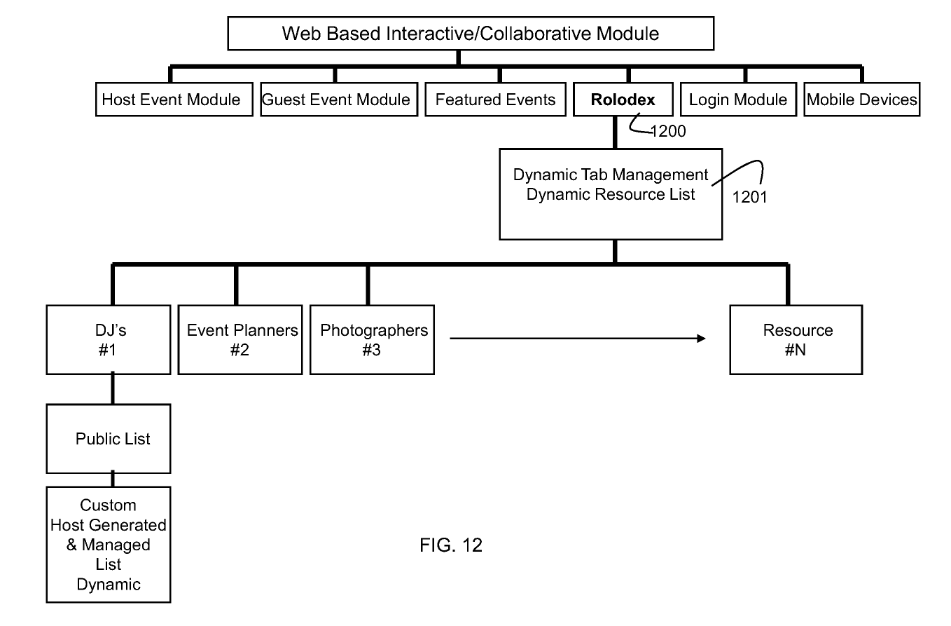

FIG. 12 shows a way for users to have access to personal and public information via the Rolodex module (1200). A unique Method to dynamically create and manage special tabs for customized categories (1201) is made available to users of this system. This information is available to users anytime, anywhere instantly.

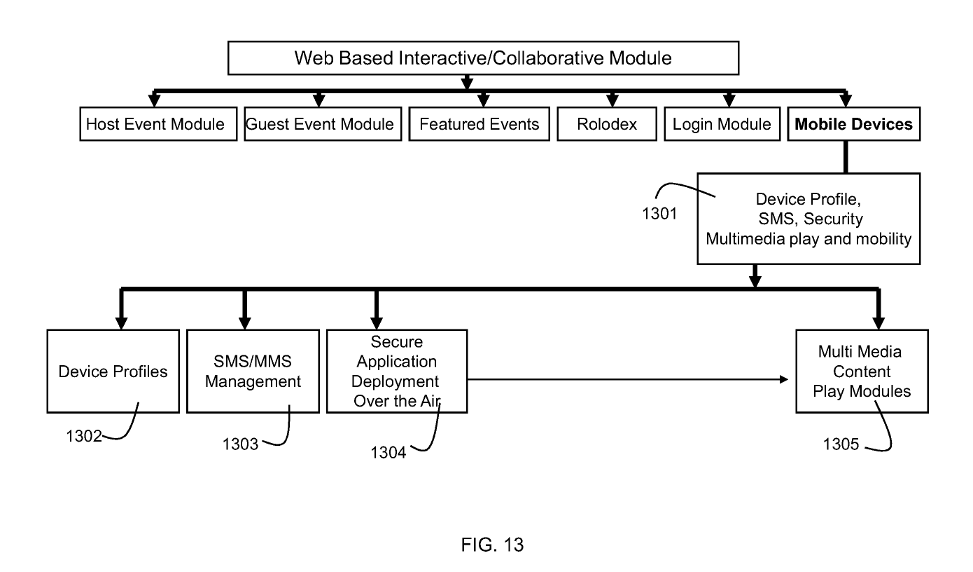

Referring to FIG. 13, another embodiment of the invention is the integration of one or more web enabled mobile devices (1301) used by one or multiple users into the web based collaborative event planning and multimedia system as described in FIG. 1. Special mobility module provides an easy way for one or multiple users to download the thin client application (1304) over the wireless interface. The application registers the device profile and configures the application to the user mobile device configuration for best rendering of the various utilities and graphic interfaces (1302). Various ways of interactive response system is built on the widely used mobile messaging system like SMS/MMS that provides instant access to the event information from anywhere anytime (1303). Another embodiment of the invention is to enable the users to search, preview, create, edit, retrieve and play the multimedia content relevant to the event anytime anywhere. Moreover the web enabled mobile devices can also be attached to other multimedia capable devices for larger arenas and bigger gatherings (1305).

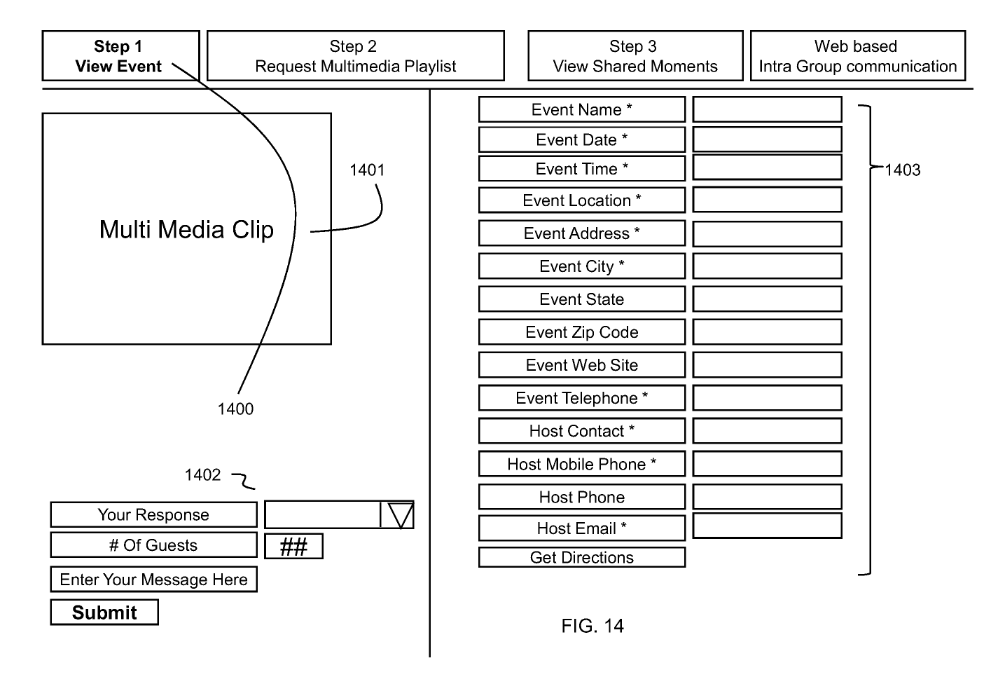

FIG. 14 describes the guest module (1400) for the web based collaborative module shown in FIG. 1. The guest receives an invitation over the internet and is securely connected to the event where the guest can view multimedia clip of the event (1401) as well details of the event (1403). The guest is now able to interactively provide their response to the invitation (1402) that is updated instantly and viewed by host and other members of the group.

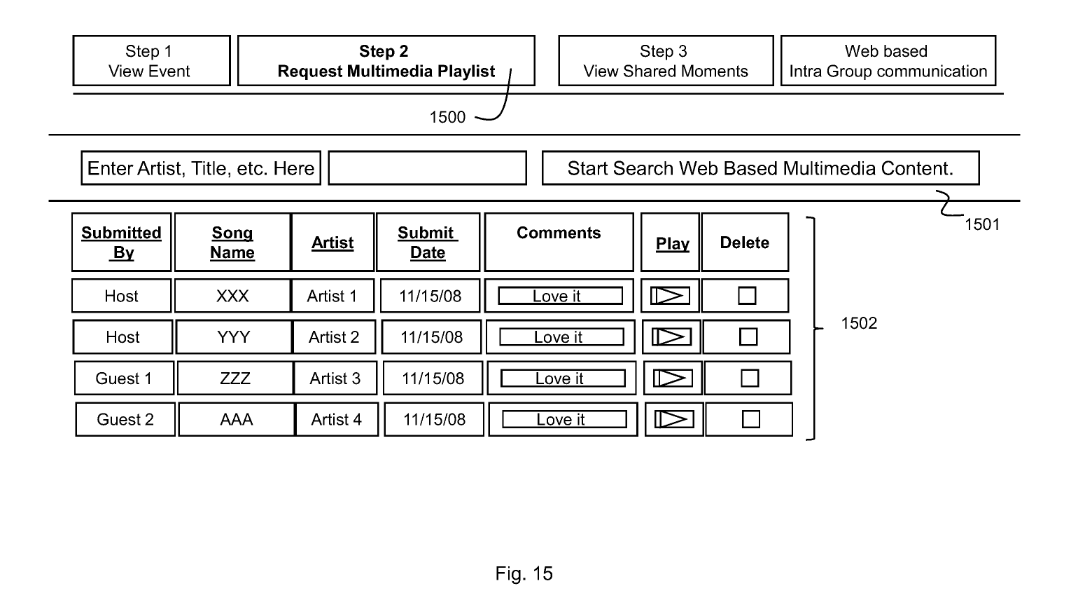

FIG. 15 describes the guest interactive multimedia module (1500). The guest is able to search multimedia playlist (1501), select one or more items to the collaborative playlist, add special dedication and messages for the event to be shared with the members of the event (1502).

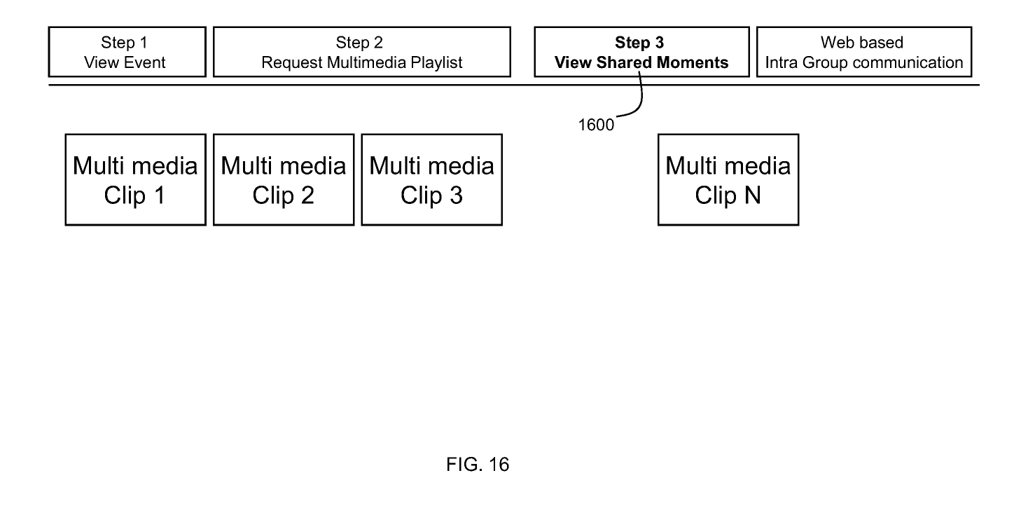

FIG. 16 shows a way for the host and guests to post and share their multimedia clips for the cherished moments (1600)

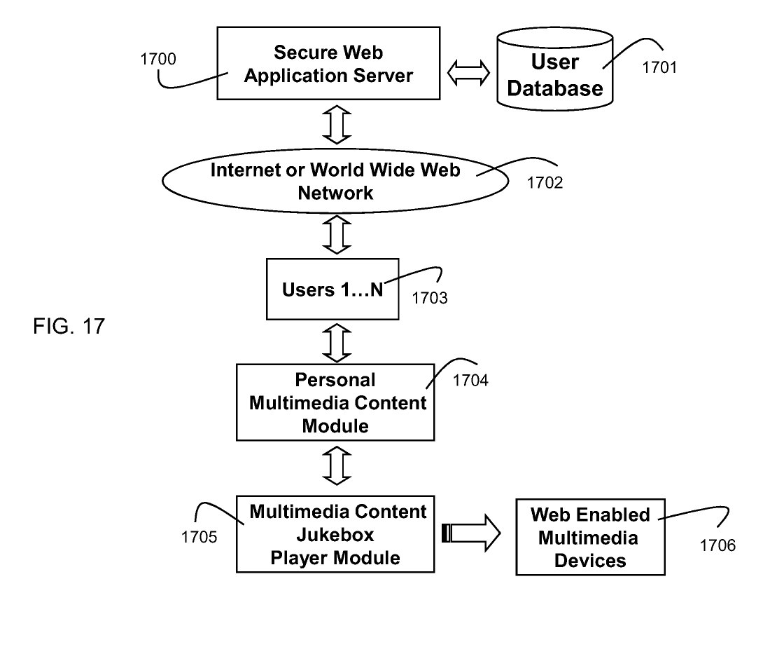

FIG. 17 shows a flow for web based personal multimedia module that is accessible anytime, anywhere over the internet 1702 without the need to store multimedia information on local devices. The secure server 1700 is personalized using a secure database 1701 and the multimedia is played 1705 using a multitude of web enabled multimedia devices 1706. Personal folders are created and maintained 1703, 1704 on the secure server.

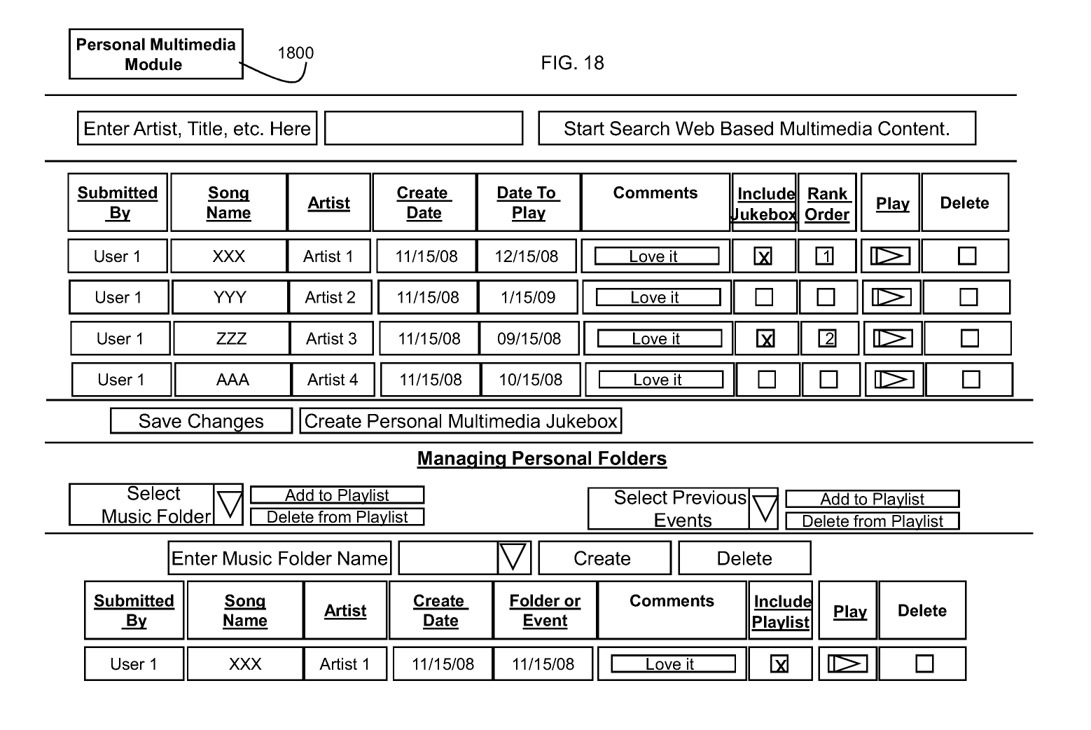

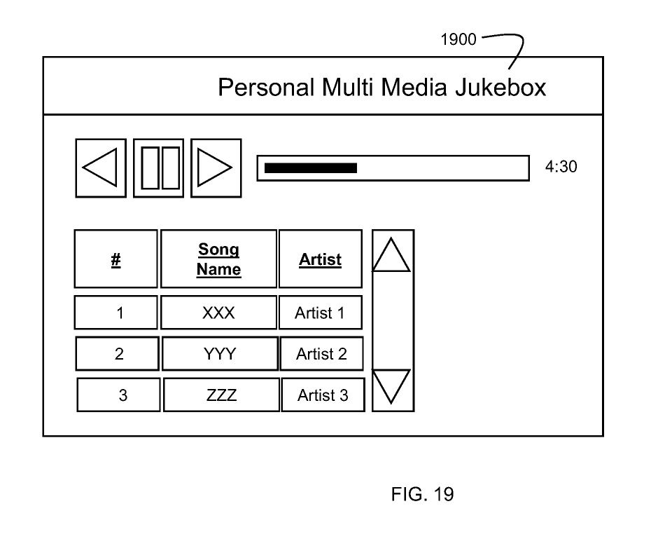

FIGS. 18 and 19 show the 1800 multimedia search, folder creation and maintenance and 1900 creation of multimedia jukebox.

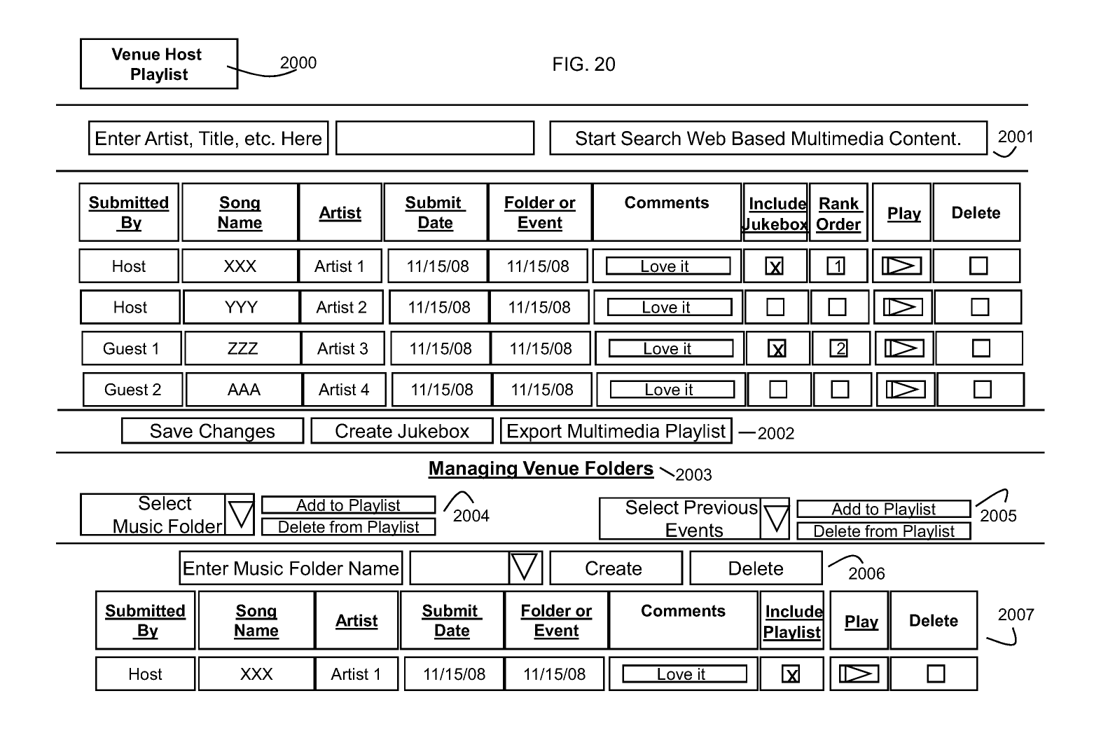

FIG. 20 shows user interface for special venues that want to collaborate with their patrons to create collaborative multimedia playlist that will be played at a predetermined date and time for creating a unique exciting experience. The host is able to see the requests for a particular date. The venue host can rank order the playlist and create a multimedia jukebox for the day.

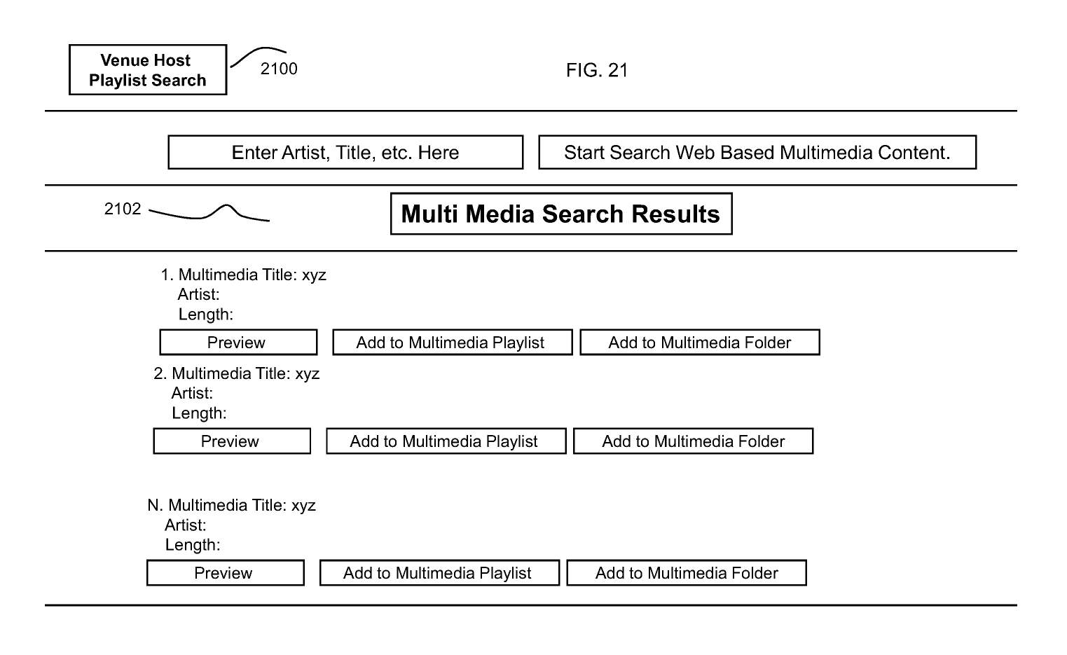

FIG. 21 shows the multimedia search capability with the capability for the venue host 2100 to create special folders 2102 for future reference.

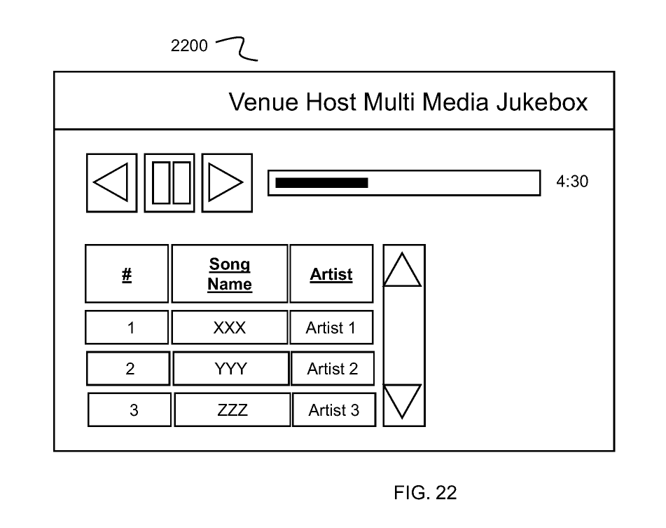

FIG. 22 shows a rank ordered venue host multimedia jukebox 2200 for the day.

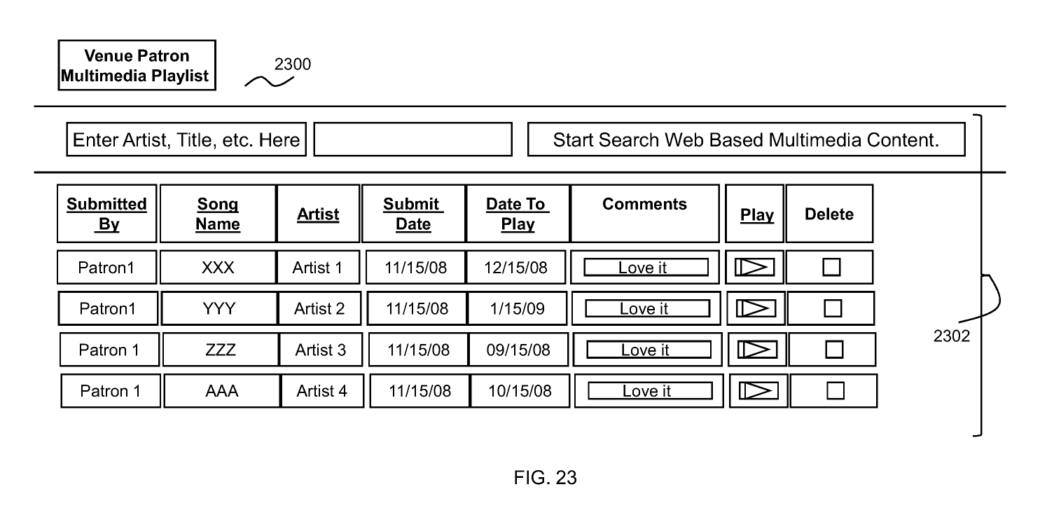

FIG. 23 shows the user interface for the venue patrons 2300 for them to request one or more multimedia playlist for a particular day and time 2302. The patron is also able to add comments or dedication.

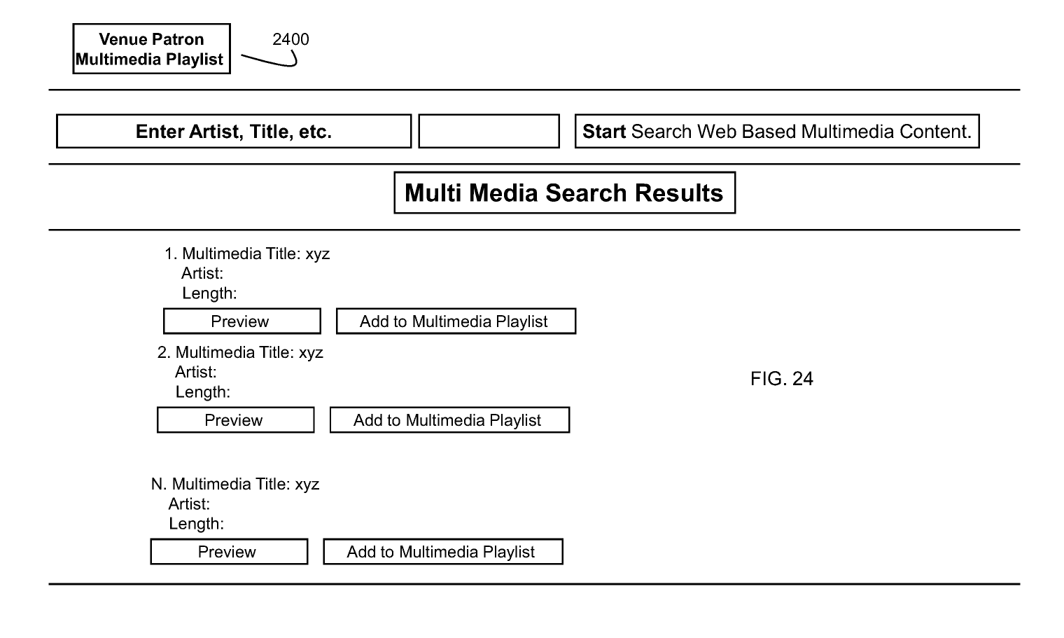

FIG. 24 shows the multimedia search capability for the venue patrons 2400.

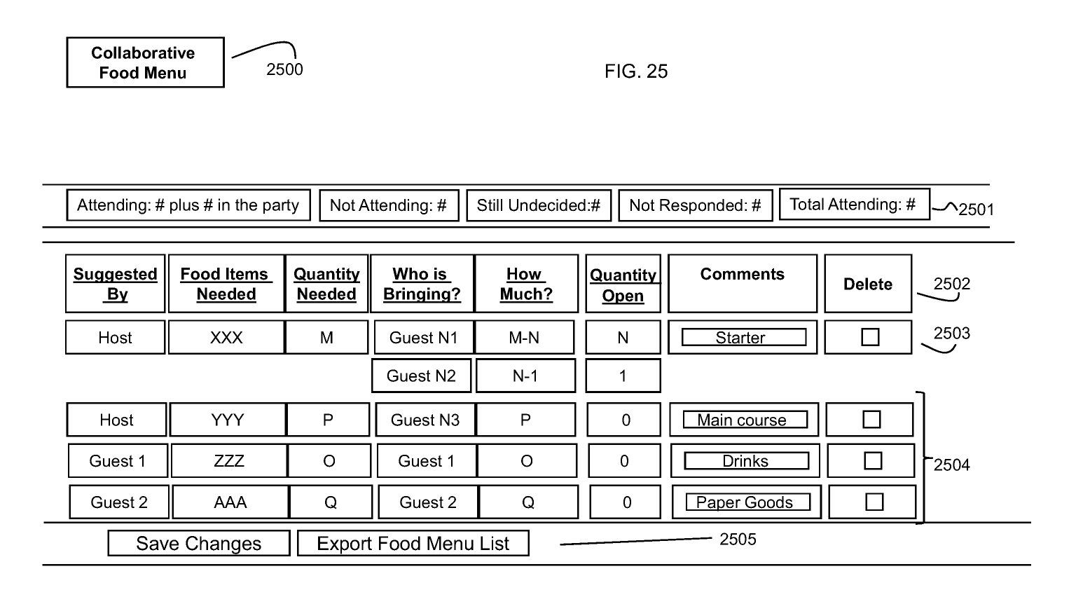

FIG. 25 shows the collaborative food menu creation module (2500). The host is able to see the number of guests who are attending the event (2501). The host is able to start a master list of food menu (2502). The host and guest are able to collaborate to assign the food items to be brought by the various members attending the event (2503). A unique embodiment is to interactively display who is bringing what and also what is still open to be brought. Another unique embodiment is for any guest to suggest food items on their behalf to add to the collaborative food menu (2504). Finally the list can be exported for sharing (2505).

The general function of each of the FIGS. in this application is clearly described in the BRIEF DESCRIPTION OF THE DRAWINGS section of this application and the specific function of each block shown in each FIG. is clearly described. Therefore, in the interest of brevity and to avoid a description that would be unduly long, and would not add to an understanding of the operation and function of the various blocks of the invention to one having ordinary skill in the art, the operation and function of the various blocks of specific FIGS., which are clearly described in the various blocks of the various FIGS., are not again repeated in prose form in this application.

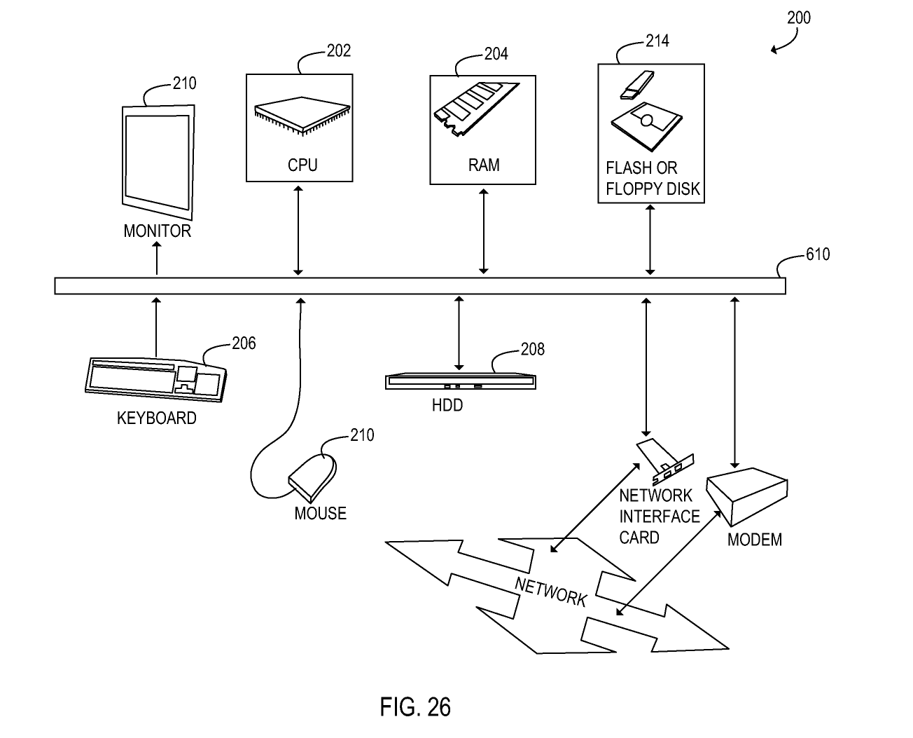

The present invention can be used on any properly configured general purpose computer system, such as the system shown in FIG. 26. Such a computer system 2600 includes a processing unit (CPU) 2602 connected by a bus 2601 to a random access memory 2604, a storage device 2608, a keyboard 2606, and a display 2610 and a mouse 2612. In addition, there is a device 2614 for entry of data and software, including software embodying the present invention, into the system. An example of such a computer can be a Dell personal computer operating on the Microsoft Windows operating system.

The various method embodiments of the invention will be generally implemented by a computer executing a sequence of program instructions for carrying out the steps of the method, assuming all required data for processing is accessible to the computer. The sequence of program instructions may be embodied in a computer program product comprising media storing the program instructions. As will be readily apparent to those skilled in the art, the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the method, and variations on the method as described herein.

The present invention may be embodied as a system, method, or computer program product. Accordingly, the present invention may take the form of a hardware embodiment, a software embodiment, or an embodiment combining software and hardware. Furthermore, the present invention may take the form of a computer program product embodied in any tangible medium of expression having computer-usable program code embodied in the medium.

Any combination of one or more computer usable or computer readable medium(s) may be utilized. Specific examples of the computer-readable medium can include: a hard disk, a random access memory (RAM), a read-only memory (ROM), an erasable programmable read-only memory (EPROM), or Flash memory, a portable compact disc read-only memory (CD-ROM), etc. In the context of this document, a computer-usable or computer-readable medium may be any medium that can be used by or in connection with the instruction execution system or apparatus. Computer program code for carrying out operations of the present invention may be written in any combination of one or more programming languages. The program code may execute entirely on the user's computer, partly on the user's computer, as a stand-alone software package, partly on the user's computer and partly on a remote computer or entirely on the remote computer or server.

The present invention is described above with reference to a computer program product according to an embodiment of the invention. It will be understood that each block, and combinations of blocks shown, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart or blocks.

These computer program instructions may also be stored in a computer-readable medium that can direct a computer or other programmable data processing apparatus to function in a particular manner, such that the instructions stored in the computer readable medium produce an article of manufacture including instructions means which implement the function specified in the blocks.

The computer program instruction may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions specified.

The flowchart in the figure illustrates the architecture, functionality, and operation of possible implementations of systems, methods and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact be executed substantially concurrently, or the blocks may sometimes be executed in the reverse order, depending upon the functionality involved. It will also be noted that each block of the flowchart illustration, and combinations of blocks in the flowchart illustration, can be implemented by special purpose hardware-based systems that perform the specified functions or acts, or combinations of special purpose hardware and computer instructions.

Based upon the foregoing, it will be apparent that there has been provided a new and useful method and system for using the Web.

While there have been shown and described and pointed out the fundamental novel features of the invention as applied to the preferred embodiments, it will be understood that various omissions and substitutions and changes of the form and details of the apparatus illustrated and in the operation may be done by those skilled in the art, without departing from the spirit of the invention.

What is claimed is:

1. A web based secure interactive system to host one or more events that can be accessed over the internet comprising:
an organizer or host organizes an event, creates an invitee list of individuals, and composes an invitation message;
said organizer or host shares, communicates and tracks the current status of each individual on the list;
said organizer or host interacts with the invitees to create a collaborative multimedia playlist.

2. The web based system of claim 1 wherein the organizer or host creates a rank ordered multimedia jukebox from a collaborative multimedia playlist.

3. The web based system of claim 2 wherein the organizer or host can play/share the multimedia playlist or the multimedia jukebox at the event using at least one of a multitude of multimedia devices.

4. The web based interactive system of claim 1 wherein the invited individuals become a subgroup who share, interact or follow the various activities and chat for that particular event or events with all the members of the subgroup.

5. The web based interactive system of claim 1 wherein the organizer or host collaborate with the invitees to create a food menu list; and
the invitees participate in adding food items of their choices to the food menu list.

6. The web based interactive system of claim 1 wherein the collaborative multimedia playlist produces a rank ordered list of songs by artist name or album or song title.

7. The web based interactive system of claim 1 wherein the host and guests share multimedia clips for the event.

8. The web based interactive system of claim 1 wherein the host,
selects items from the multimedia playlist;
previews the content of selected items from the multimedia playlist;
adds selected items from the list to a master multimedia playlist; and
adds comments, and messages to the selected items on the master multimedia playlist.

9. The web based interactive system of claim 1 wherein a master multimedia playlist is shared with the invitee list of individuals participating at an event; the invitee list of individuals participating at an event add additional songs and multimedia clips to the master multimedia playlist tracked by their individual identity; and the invitee list of individuals participating at an event add personalized messages for each selected songs and multimedia clips to the master multimedia playlist.

10. The web based interactive system of claim 1 further including, creating new personal folders with various names or categories; adding the selected items from the list to various personal folders; modifying or deleting old personal folder names;
and
adding the selected items in the personal folders, to the master multimedia playlist.

11. The web based system of claim 1 where in the organizer or host allows the same visibility to each selected invitee.

12. A web based secure interactive personal system to search, select, and creates one or multiple multimedia playlists that can be accessed from a centralized server over the internet comprises;
producing a list of songs by artist name or album or song title;
producing a list of video songs by artist name or album, or song title; and
producing multimedia clips by title or author or subject.

13. The web based system of claim 12 further comprises:
selecting at least one song or video song from the list;
previewing the content of the at least one selected song or video song from the list;
creating at least one customized folder with an easy to remember name; and
adding at least one select song or video song from the list, to the at least one customized folder.

14. The web based system of claim 12 further comprises:
creating one or more multimedia playlist;
adding one or more selected song or video song from the list or at least one folder to the multimedia playlist;
deleting one or more of the songs or video songs on the multimedia playlist; and
rank ordering the songs or video songs on the multimedia playlist.

15. The web based system of claim 12 further comprises:
playing one or more of the multimedia playlist from the list; and
playing all the items within a selected multimedia playlist using at least one of a multitude of web enabled multimedia devices, portable or stationary.

16. A web based secure interactive system for small to large establishments with their patrons comprising;
an owner of the establishment interacts with their patrons to create a collaborative multimedia playlist for specified date and time:
said owner creates a multimedia jukebox player from the multimedia playlist that can be played at the establishment using one or more of an audio player, video player, and hand held multimedia player, phone, or personal computer.

17. The web based system of claim 16 further comprises:
selecting, adding and/or deleting one or more items from the multimedia playlist; and
rank ordering the items on the multimedia playlist.

18. The web based system of claim 16 further comprises:
previewing one or more selected items on the multimedia playlist;
composing the finalized multi media playlist with at least one of, artist name, album, author, title, playtime etc., along with the messages from requestors; and
playing the final composed multimedia playlist with at least one of a feature of, play, pause, skip rewind, stop shuffle, and/or sequential play, using at least one of the multitude of multimedia play devices.

19. The web based interactive system of claim 5 wherein the host or organizer
creates details of the event time, place and occasion; the host or organizer starts a master list of food items that are needed for the event; and the invitees and host sign up for bringing the selected food item, until all the required food items are fully assigned.

20. The web based interactive system of claim 19 wherein the host finalizes the food menu list that contains food items with associated names and quantities, and made visible to all host and invitees to the event.
